(19) United States
(12) Patent Application Publication
(10) Pub. No.: US 2007/0150423 A1
(43) Pub. Date: Jun. 28, 2007

(54) Low cost system and method for updating secure data in internal flash while driving motors and printing

(76) Inventors: Wesley A. Kirschner, Farmington, CT (US); Gary S. Jacobson, Norwalk, CT (US)

Correspondence Address: George M. Macdonald, Pitney Bowes Inc.;Intellectual Property and Technology Law Dept., 35 Waterview Drive, P.O. Box 3000, Shelton, CT, 06484, US

(21) Appl. No.: 11/317,997

(22) Filed: Dec. 22, 2005

(51) Int. Cl. G06F 17/00

(52) U.S. Cl. 705/408

(57) ABSTRACT

A method includes retrieving and printing a first portion of an information based indicia (IBI) from a memory, and writing at least one datum to a flash memory while retrieving and printing a second portion of the IBI from the memory.

### BACKGROUND OF THE INVENTION

1. Field of the Invention

The present invention relates generally to a system for maintaining high print speed while storing secure data.

2. Background Information

Postage evidencing systems are secure postage metering systems that generate indicia imprinted on or affixed to a mail piece to evidence prepayment of postage. For example, the postal services of various countries regulate these systems and their use to protect postal revenue. Typically, only postal service authorized manufacturers or product service providers may design, produce, and distribute the systems. The misuse of a postage evidencing system to avoid payment of postage is punishable by law.

The major components of a postage evidencing system include funds registers and accounting functions to store and maintain financial data, indicia generated by the system to show evidence of postage prepayment on a mail piece, and USPS and provider infrastructure. The generated indicia are referred to as “meter stamps” or “metered postage.” Herein, the terms “indicia” and “indicium” are used interchangeably.

Second generation (Generation 2) postage evidencing systems are increasingly utilized to facilitate the metering of mail. Such Generation 2 postage evidencing systems utilize a postal service approved electronic component called a “postal security device” (PSD) for managing the registers and accounting for postal funds. All PSDs must meet specified performance criteria and must have a self-disabling feature that prohibits the printing of postage when specific programmed requirements are not met. For all Generation 2 postage evidencing systems the provider and the postal service infrastructure must interface to support licensing and customer information, ensure proper payment for postage, and provide for inventory management.

With particular reference to the managing of registers by the PSD, there exists the potential for user fraud. It should be noted that the ability to generate meter stamps is, in many ways, analogous to the ability to print currency, a right most often reserved to the federal governments of the countries authorizing the use of PSDs. Meter stamps, like cash or other forms of currency, are fungible commodities with an express monetary value capable of being affixed to a variety of postage parcels. Once affixed, the meter stamp serves as proof of a purchase for the service of delivery of the parcel through the mail system.

Typically, a plurality of meter stamps are printed in a continuous role as it is desirable to maintain a constant movement of roll past the print heads operating to print the postage indicia upon the role. Failure to maintain a constant rate of advance, or speed, requires the unnecessary and unwanted acceleration and deceleration of the print medium. For each printed meter stamp, the PSD is required to update a state register maintaining an electronic record of, amongst other things, the user's account information. For example, for each meter stamp that is printed, the state register is updated to record the printing of the meter stamp and to perform any financial functions associated with the printing.

As noted above, printed meter stamps are fungible and can be used much like currency. As a result, there exists the possibility of fraud whereby an operator of a PSD can manipulate its operation to secure a printed postage stamp without an accompanying electronic record of the printing of the meter stamp. For example, in the instance where the meter stamp is completely printed prior to the PSD updating the state register, an operator of the PSD could deactivate, such as by turning off the power supply to the PSD, the printing process after the printing of the meter stamp but before an electronic record of such printing has been recorded. In such an instance, the user retains in his possession a meter stamp of monetary value for which there is no record by which to receive equivalent monetary compensation from the user.

Conversely, if the state register is updated prior to printing the meter stamp, a user of the PSD can be charged for the creation of a meter stamp in the absence of the successful creation of the meter stamp. This situation arises as a result of the state register having been updated followed by an incomplete or inadequate production of a corresponding meter stamp, such as might arise from an inadvertent power outage. As a result, the user of the PSD is charged without any proof that the meter stamp failed to print.

It is therefore obvious that updating the state register of a PSD either prior to or following the printing of a meter stamp gives rise to a potential for improper accounting at the least, as well as possible fraudulent activity. Unfortunately, it is increasingly common for devices, such as PSDs, to rely on flash memory to store information such as state registers. It is an attribute of flash memory that when it is written it is necessary to disable interrupts to the CPU controlling the writing of data to the flash memory. As a result, updating a state register stored in flash memory while a meter stamp is being printed requires disabling interrupts to the integrated circuit. Such a disablement prevents the CPU from receiving and responding to interrupts which are required to control the printing of the meter stamps.

There is therefore needed a method for updating a state register on a flash memory operating as part of a PSD in a manner that does not produce undesirable control issues arising from a disabling of interrupts.

### SUMMARY OF THE INVENTION

In accordance with an embodiment of the invention, a method includes retrieving and printing a first portion of an information based indicia (IBI) from a memory, and writing at least one datum to a flash memory while retrieving and printing a second portion of the IBI from the memory.

In accordance with an alternative embodiment of the invention, an apparatus includes a microprocessor comprising a CPU coupled to a DMA device and an internal flash memory, a first memory including a first portion of an IBI and a second portion of an IBI the first memory coupled to the DMA, wherein the DMA device operates to transfer each of the first portion and the second portion to a print head at spaced times.

In accordance with an alternative embodiment of the invention, a program of machine-readable instructions, tangibly embodied on an information bearing medium and executable by a digital data processor, perform actions directed toward updating a flash memory, wherein the actions include directing a DMA device to transfer a first portion of an IBI from a memory to a device, directing the DMA device to transfer a second portion of the IBI from the memory to the device, and updating at least one datum stored on the flash memory while the second portion of the IBI is transferred.

### BRIEF DESCRIPTION OF THE DRAWINGS

The foregoing aspects and other features of the present invention are explained in the following description, taken in connection with the accompanying drawings, wherein:

FIG. 1a is a diagram of an exemplary embodiment of a first side of a meter stamp.

FIG. 1b is a diagram of an exemplary embodiment of a second side of a meter stamp.

FIG. 2 is a diagram of an exemplary embodiment of a system for practicing the invention.

FIG. 3 is a flow chart of an exemplary embodiment of the method of the invention.

FIG. 4 is a diagram of an exemplary embodiment of a stepper motor control apparatus.

### DETAILED DESCRIPTION

In an exemplary embodiment of the invention, there is provided a method for updating secure data, such as that stored in a state register of a PSD, during the printing of an indicia. In an exemplary embodiment, the indicia is a meter stamp. The method operates by identifying a portion of time corresponding to the printing of a predetermined expanse of a meter stamp during which interrupts to a CPU controlling the printing of the indicia can be disabled. In a preferred embodiment, the portion of the meter stamp formed of a two-dimensional (2D) bar code is divided into two portions. When printing of the second portion of the 2D bar code begins, the secure data is updated. As will be described more fully below, the updating of the secure data is performed in a manner that reduces the likelihood of user fraud or incorrect accounting arising as described above.

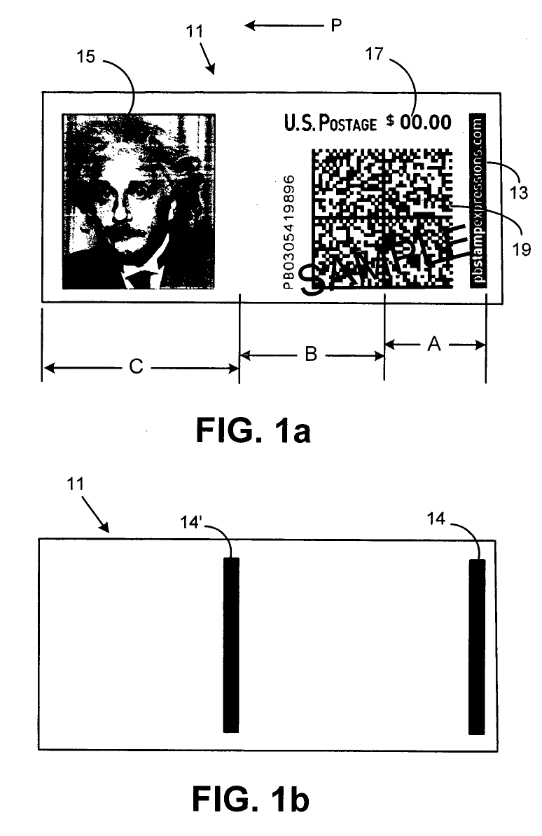

With reference to FIGS. 1a and 1b, there is illustrated an example of a front and rear side, respectively, of single postage meter stamp 11 detailing the component portions of the meter stamp 11. Meter stamp 11 is formed of an information based indicia (IBI) 19 about which is printed security data 13, a postage amount 17, and a graphic 15. In a preferred embodiment, the IBI 19 is formed of a 2D barcode in which is encoded the licensing post office, the rate category, the date of mailing, the postage amount, and a device or meter ID number. As the exemplary embodiments described herein are directed to meter stamps 11 utilizing 2D barcodes, IBI 19 is interchangeably referred to as “2D barcode 19”.

While illustrated as a single meter stamp 11, the meter stamp 11 forms but one of a plurality of meter stamps 11 to be printed upon a media, usually in the form of a roll, that is advanced through a printer. The meter stamp 11 is printed in a direction P with the security data being printed prior to the 2D bar code 19 which is printed prior to the graphic 15.

With reference to FIG. 1b, there is illustrated a back side of meter stamp 11. Meter stamp 11 is formed of a plurality of media marks 14. Media marks 14 can be optically observed by the PSD during the printing of one or more meter stamps 11. Once observed, media marks 14 can give rise to one or more interrupts indicative of a current state of the media. For example, a single media mark 14 is used to indicate the beginning of a new meter stamp 11 to be printed. Additional media marks 14 include indicia such as end of roll.

During printing, an interrupt generated by the observation of a media mark 14 indicating the beginning of a new meter stamp 11 instructs a CPU controlling the print process to begin printing meter stamp 11. As illustrated, the printing of a single meter stamp 11 is divided into three portions. Portion A extends from the leading edge of media mark 14 through a portion of 2D barcode 19, preferably approximately half-way across 2D barcode 19. Portion B extends from the halfway point of 2D barcode 19 to a leading edge of media mark 14′. Media mark 14′ is indicative of the point at which the graphic 15 is to be printed. Lastly, portion C extends from the leading edge of media mark 14′ until an edge of meter stamp 11 forming the further most boundary of meter stamp 11.

While printing portion A, it is not preferable to update the security registers. As its name implies, an information based indicia 19 encodes information which can be decoded to provide information about the meter stamp 11. With specific regard to the 2D barcodes 19 utilized in meter stamps 11, such as the one illustrated, successful completion of the printing of portion A, without the printing of any part of portion B, results in the printing of a portion of the 2D barcode 19 sufficient to entitle the bearer of such a partially printed meter stamp 11 to a refund of postage paid. Specifically, the first half of the 2d barcode encodes all of the information necessary that, upon decoding, serves to verify the entitlement of a bearer of a meter stamp 11 to a refund. If the state registers maintaining data regarding the state of a meter stamp 11 were to be updated during the printing of portion A, and the printing of the meter stamp was disabled prior to the end of printing portion A, the user of the PSD would be charged for a meter stamp 11 on which is printed insufficient data to entitle the user to a refund.

Conversely, it is not preferable to wait until after printing portion B to update the security registers. As illustrated, during the printing of portion B, the second half of the 2D barcode 19 is printed. The printing of the entire 2D barcode 19 upon the meter stamp 11 is required in order for the meter stamp 11 to ensure delivery of the parcel to which it is attached. Therefore, if the state register is not updated until the beginning of portion C, printing can be terminated after a completed 2D barcode 19 is printed but before the state register is updated to indicate that a valid meter stamp was printed. In such a situation, a user can acquire a functional meter stamp without tendering payment.

The USPS desires that PSDs be enabled to update or otherwise alter state information, such as a state register, during the printing of the 2D barcode 19. For the reasons discussed above, it is not preferable to update such state information during the printing of portion A of a meter stamp 11. In an exemplary embodiment of the invention described more fully below, the image forming the 2D barcode 19 is divided into two portions and stored in a memory. Specifically, the 2D barcode 19 is divided into a first portion contained within portion A, and a second portion contained within portion B. Preferably, a first portion of the 2D barcode 19 includes, typically in encoded form, sufficient information to enable a refund of the meter stamp 11 postage amount. The complimentary second portion of the 2D barcode 19 is similarly stored in a memory. As a result, once portion B commences to print, updates to the memory device upon which the state information is stored may be performed. During this time, the image data required to print the second portion of the 2D barcode is retrieved from the memory upon which it is stored allowing interrupts to be disabled to the memory in which resides the state registers.

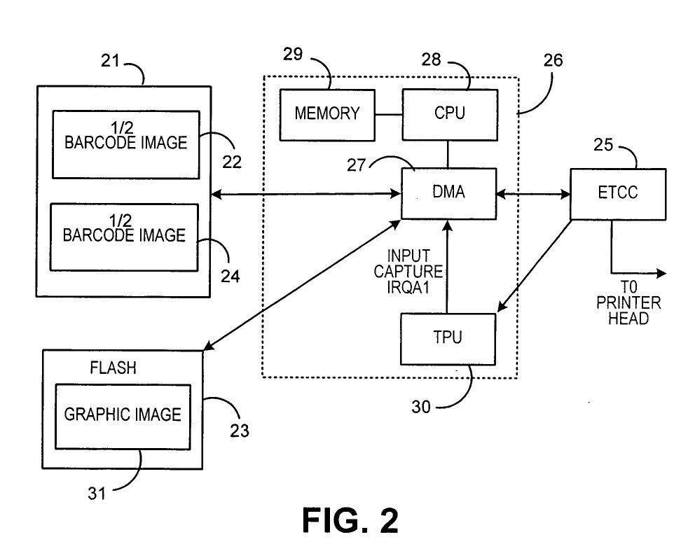

With reference to FIG. 2, there is illustrated the interaction of various components to enable exemplary embodiments of the invention. An application specific integrated circuit (ASIC) 25 is a processor and is utilized to receive an input signal, via a direct memory access (DMA) device 27 coupled to the ASIC 25 and to output a signal to a printer head for printing a meter stamp 11. DMA device 27 is coupled to and set up by the CPU 28 and functions to transfer data directly from a fast i/o device to/from memory. CPU 28 is coupled to internal flash memory 29. CPU 28, internal flash memory 29, and DMA device 27 form parts of microprocessor 26. Microprocessor can be any microprocessor including, but not limited to, a Hitachi (Renasys) 2218.

As illustrated, DMA device 27 is coupled to a first memory 21 and a second memory 23. Preferably, first memory 21 is formed of external random access memory (RAM). By “external” it is meant that the memory is physically located outside of the microprocessor 26 within which resides CPU 28. In the exemplary embodiment shown, first memory 21 has stored within it a first image 22 and a second image 24. First image 22 corresponds to a first portion of the 2D barcode 19 while second image 24 corresponds to a second portion of the 2D barcode 19. Specifically, first image 22 corresponds to the portion of the 2D barcode 19 printed during printing of portion A and second image 24 corresponds to the portion of the 2D barcode 19 printed during printing of portion B. Second memory 23 stores additional image data such as that forming graphic 15. Second memory 23 may be formed of any digital memory medium but is preferably a flash memory device. While illustrated as stored on separate memories 21, 23, the first image 22, second image 24, and additional image data 31 may all be stored on the same memory device.

While the DMA device 27 is configured by the CPU 28, its operation is controlled by a timing pulse unit (TPU) 30. In typical operation, when the ASIC 25 is ready for more data, a “Ready” signal is sent to the TPU which proceeds to drive the DMA channel associated with the DMA device 27 so as to transfer additional data as will be described more fully below. As noted, internal flash memory is coupled to the CPU 28. By “internal” it is meant that the memory is physically located inside of the microprocessor within which resides CPU 28. The state registers are maintained on third memory 29. Storing the state registers in internal flash memory decreases the likelihood of data corruption resulting from external forces, such as tampering. An output of ASIC 25 is coupled to a printer head (not shown) to control the printing of the meter stamp 11.

As illustrated, the CPU 28, the TPU 30, DMA device 27, and internal flash memory 29 are located on a single microprocessor 26. Example of microprocessors suitable for conducting the method of the invention include, but are not limited to Hitachi microprocessors.

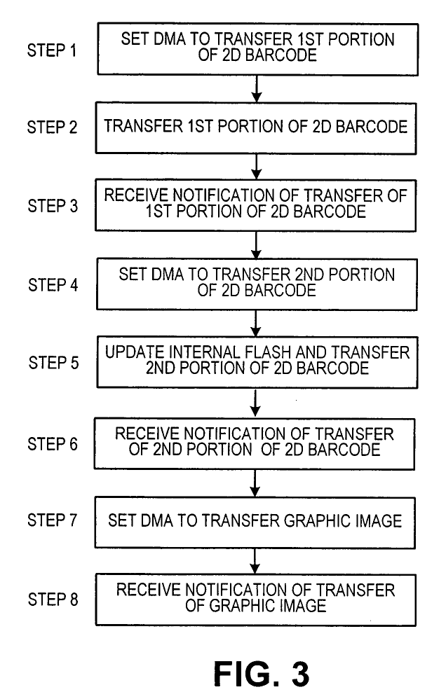

With reference to FIG. 3, there is illustrated an exemplary embodiment of the method of the invention. At step 1, the DMA device is instructed by the CPU 28 to transfer first image 22 from a first memory 21 to the ASIC 25. At step 2, the data comprising first image 22 is transferred from first memory 21 to the ASIC 25. In the exemplary embodiment, first image 22 is a portion of the 2D barcode 19 sufficient, if printed, to enable a user to obtain a refund while being not sufficient to provide postage to an article to which it is attached.

At step 3, notification is sent by the DMA device 27 to the CPU 28, preferably in the form of an interrupt request (IRQ). The IRQ is received by the CPU 28 to indicate that the first image was successfully transmitted from the first memory 21 to the ASIC 25. At step 4, the DMA device is instructed by the CPU 28 to transfer the second image 24 from a first memory 21 to the ASIC 25.

At step 5, while the transfer of the second image 24 from first memory 21 is in process following step 4, the internal flash memory is updated. Such updating includes, but is not limited to, updating security data such as state registers. As is evident from the discussion of portion B above, step 5 is performed during the period of time required to print portion B of meter stamp 11. Portion B extends for a length of at least the horizontal expanse of the second portion, preferably a half of the 2D barcode 19. In practice, this expanse is approximately 8 mm in length. Assuming that the media upon which the meter stamp 11 is being printed is moving at approximately 0.67 inches/second (˜17 mm/sec), the printing of portion B continues for a period of time of at least 0.47 (470 ms) seconds in duration.

As noted above, internal memory 29 is preferably a flash memory device. Such internal flash memory devices require that data sent to the flash memory device be composed in units of 128 bytes in length. Optimally, a data block having a length of 128 bytes can be written to a flash memory device in approximately 10 ms. However, as flash memory devices age, the amount of time required to write data to them increases. It is not uncommon for a 128 byte data block to require upwards of 200ms to be written to a flash memory device, such as third memory 29.

As illustrated, portion B extends from the beginning of the second portion of 2D barcode to a leading edge of media mark 14′. As this distance is typically approximately twice the distance required to print the second portion of the 2D barcode, or approximately 16 mm, the printing of portion B typically requires approximately one second to print. Therefore, in this exemplary example, approximately five writes per second to internal flash memory 29 can be performed during the time required to print portion B. In the event that a single write to update a state register is performed, such an update can be performed in less time than is required to print the second portion of 2D barcode 19. As noted above, interrupts to the CPU 28 are disabled while the CPU 28 is writing to the internal flash memory 29. In addition, media mark 14′, forming a low media or end of media mark, can be shifted towards portion C a distance sufficient to insure that the flash memory 29 update is completed prior to encountering the media mark 14′.

At step 6, the CPU 28 receives notification that second image 24, including at least the second portion of the 2D barcode, has finished printing. Preferably, such notification is in the form of an IRQ sent from the DMA device 27 to the CPU 28. In this manner, the first and second portions of the 2D barcode are transferred and printed at spaced times. Next, at step 7, the CPU 28 sets the DMA device 27 to transfer the additional image data 31 from the second memory 23 to the ASIC 25. As the additional image data 31 does not form a required part of meter stamp 11, performance of step 7 is optional. Lastly, after the transfer of the additional image data 27 from step 7 is complete, an IRQ is sent from the DMA device 27 to the CPU 28 notifying the CPU 28 of the successful transfer. The operation of the CPU 28 can be directed via the execution of code stored on an information bearing medium, such as electronic memory coupled to the CPU 28.

As noted above, while internal flash memory 29 is being updated in step 5, interrupts to CPU 28 are disabled. As data is transferred from either of first memory 21 or second memory 23, the ASIC 25 functions to output the transferred data to the printer head. In addition to the operation of the print head to print the graphical data forming all of the graphical elements of meter stamp 11, it is necessary to control the operation of the stepper motor operating to advance the media upon which the meter stamp 11 is printed.

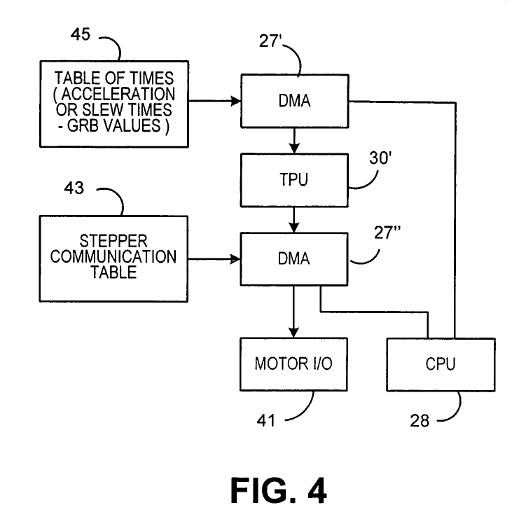

With reference to FIG. 4, there is illustrated a diagram of an exemplary embodiment of components utilized to control the operation of a stepper motor. A step table 43 defines modes of operation, such as full-step and half-step, of a stepper motor. Step table 43 may be stored on a form of memory device capable of retrieving the data forming the step table 43 and outputting the data to DMA device 27″. Times table 45, coupled to DMA device 27′, stores timing information related to when each step in step table 43 is to be applied to the stepper motor. As illustrated, both DMA devices 27′, 27″ are coupled to CPU 28 for controlling their operation. Typical microprocessors provide for a plurality of DMA devices 27. DMA 27″ operates to transfer stepper commutation data from step table 43 to the motor I/O 41 of the stepper motor. The timing of such transfers is controlled by TPU 30′ coupled to DMA 27′. A more detailed recitation of the functioning of the apparatus illustrated in FIG. 4 may be found in U.S. Pat. No. 5,574,351 to Jacobson et al., issued Nov. 12, 1996, and is incorporated by reference herein. Suffices to note that the illustrated exemplary embodiment of the apparatus operates, at the direction of CPU 28, to control the operation of a stepper motor without the need to send interrupts to the ASIC 25. As a result, the stepper motor is effectively controlled so as to allow the suspension of interrupts to CPU 28 while updating internal flash memory 29.

There is therefore provided an apparatus and a method for securing data in a flash memory while driving motors and printing. The method taught herein enables such operation in a manner requiring low cost. The method further enables writing to a flash memory in variable fashion over a substantial margin of time. Such a variable fashion permits the extension of the invention to a scenario wherein multiple security updates are performed during each print cycle. By utilizing one or more DMA devices to implement the transfer of data, microprocessor overhead is minimized. Utilizing internal flash memory reduces the amount of hardware required to provide security. Lastly, the method and apparatus of the invention eliminates the need to stop the print motor when writing to flash memory.

In an alternative, a display key interlock latch may be added. For example, keys on a display are typically handled by interrupt as well. Adding a small latch to the illustrative embodiments of the application can solve this problem so that after the postal state is updated, the latch can be moved and the key can be read and processed. Additionally, the USB and other communication channels are also disabled. However, the protocols can alternatively be designed to retry messages across the time it takes for the postal state to be updated.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method comprising:
retrieving and printing a first portion of an information based indicia (IBI) from a first memory; and
writing at least one datum to a flash memory while retrieving and printing a second portion of said IBI from said first memory.

2. The method of claim 1 wherein said IBI comprises a 2D barcode.

3. The method of claim 1 wherein said IBI comprises a postage indicium.

4. The method of claim 1 wherein said first portion comprises a proof of purchase of a meter stamp.

5. The method of claim 1 wherein said retrieving comprises retrieving said first portion of said information based indicia from a random access memory (RAM).

6. The method of claim 1 wherein said at least one datum comprises a state register.

7. The method of claim 1 wherein said writing said at least one datum comprises disabling at least one interrupt signal to a CPU and utilizing said CPU to write to said flash memory.

8. The method of claim 8 comprising situating said CPU and said flash memory on a microprocessor.

9. The method of claim 1 comprising retrieving and printing an additional image data.

10. The method of claim 1 wherein said retrieving said first portion comprises utilizing a first direct memory access (DMA) device.

11. The method of claim 10 wherein said first DMA device is controlled by a CPU.

12. The method of claim 1 comprising utilizing a CPU to control a stepper motor via a second DMA device coupled to a times table and a third DMA device coupled a step table.

13. An apparatus comprising:
a microprocessor comprising a central processing unit (CPU) coupled to a direct memory access (DMA) device and an internal flash memory;
a first memory coupled to said DMA comprising a first portion of an information based indicia (IBI) and a second portion of said IBI;
wherein said DMA device operates to transfer each of said first portion and said second portion to a print head at spaced times.

14. The apparatus of claim 13 comprising a state register stored in said internal flash memory and alterable while said second portion is transferred to said print head.

15. The apparatus of claim 13 wherein said first memory comprises a RAM.

16. The apparatus of claim 13 comprising a second memory coupled to said DMA comprising an additional image data.

17. The apparatus of claim 13 wherein said IBI comprises a 2D barcode.

18. The apparatus of claim 13 wherein said IBI comprises a postage indicium.

19. A program of machine-readable instructions, tangibly embodied on an information bearing medium and executable by a digital data processor, to perform actions directed toward updating a flash memory, the actions comprising:
directing a DMA device to transfer a first portion of an IBI from a memory to a device;
directing said DMA device to transfer a second portion of said IBI from said memory to said device; and
updating at least one datum stored on said flash memory while said second portion of said IBI is transferred.

20. The program of claim 19 wherein said IBI comprises a 2D barcode.

21. The program of claim 19 wherein said IBI comprises a postage indicium.

22. The program of claim 19 wherein said first portion comprises a proof of purchase of a meter stamp.

23. The program of claim 19 wherein said memory comprises a RAM.

24. The program of claim 19 wherein said at least one datum comprises a state register.

25. The program of claim 24 wherein said updating comprises disabling at least one interrupt signal to a CPU and utilizing said CPU to write to said flash memory.
